(19) United States
(12) Patent Application Publication
(10) Pub. No.: US 2010/0019109 A1
(43) Pub. Date: Jan. 28, 2010

(54) Reverse Foldable Camera Tripods

(76) Inventor: Hao Liu, Zhongshan (CN)

Correspondence Address: BRINKS HOFER GILSON & LIONE, P.O. BOX 10395, CHICAGO, IL, 60610, US

(21) Appl. No.: 12/179,148

(22) Filed: Jul. 24, 2008

(51) Int. Cl. F16M 11/38

(52) U.S. Cl. 248/168; 248/166; 248/188

(57) ABSTRACT

A tripod comprises a main body with three radially extending arms, and a leg connected to each arm so as to pivot through about 180 degrees with respect to the main body, so as to pivot between a first position wherein the leg is generally parallel to and below the main body, and a second position wherein the leg is generally parallel to and above the main body. Each arm includes at least one projection for releasably fixing the connected leg at a third position between the first and second positions. In one aspect, each leg includes an angle lock for engaging the projection on the arm, the angle lock mounted to a top end of the leg and configured to move in a radial path, relative to the main body, into and out of engagement with the projection. In another aspect, each leg includes an angle lock for engaging the projection on the arm, the angle lock mounted to a top end of the leg and configured to move in an axial path, relative to the leg, into and out of engagement with the projection. In yet another aspect, each leg includes an angle lock for engaging the projection on the arm, the angle lock pivotally mounted to a top end of the leg and configured to pivot into and out of engagement with the projection.

### FIELD OF THE DISCLOSURE

The present disclosure relates to support devices, such as foldable tripods for cameras, small telescopes, binoculars, and other apparatus.

### BACKGROUND OF THE DISCLOSURE

Various types of tripods are currently available. Most tripods include a center body and legs connected to the center body. It is desirable for the tripods to be foldable such that the tripods occupy a smaller space, are easier to move, and have a more elegant appearance.

### BRIEF SUMMARY OF THE DISCLOSURE

In one aspect, a tripod comprises a main body with three radially extending arms, and a leg connected to each arm so as to pivot through about 180 degrees with respect to the main body, so as to pivot between a first position wherein the leg is generally parallel to and below the main body, and a second position wherein the leg is generally parallel to and above the main body. Each arm includes at least one projection for releasably fixing the connected leg at a third position between the first and second positions. Each leg includes an angle lock for engaging the projection on the arm, the angle lock mounted to a top end of the leg and configured to move in a radial path, relative to the main body, into and out of engagement with the projection.

In another aspect, a tripod comprises a main body with three radially extending arms, and a leg connected to each arm so as to pivot through about 180 degrees with respect to the main body, so as to pivot between a first position wherein the leg is generally parallel to and below the main body, and a second position wherein the leg is generally parallel to and above the main body. Each arm includes at least one projection for releasably fixing the connected leg at a third position between the first and second positions. Each leg includes an angle lock for engaging the projection on the arm, the angle lock mounted to a top end of the leg and configured to move in an axial path, relative to the leg, into and out of engagement with the projection.

In yet another aspect, a tripod comprises a main body with three radially extending arms, and a leg connected to each arm so as to pivot through about 180 degrees with respect to the main body, so as to pivot between a first position wherein the leg is generally parallel to and below the main body, and a second position wherein the leg is generally parallel to and above the main body. Each arm includes at least one projection for releasably fixing the connected leg at a third position between the first and second positions. Each leg including an angle lock for engaging the projection on the arm, the angle lock pivotally mounted to a top end of the leg and configured to pivot into and out of engagement with the projection.

### BRIEF DESCRIPTION OF THE DRAWINGS

FIG. 1 is a side view of an apparatus tripod in a reversely folded condition according to a first embodiment.

FIG. 2 is a side view of an apparatus tripod, with a typical ballhead 75 attached to a mounting screw 70 (hidden) shown on the center column, in a reversely folded condition according to the first embodiment, and demonstrating the ability of the apparatus mount ballhead 75 to be self-contained within the confines of the fully closed tripod dimensions.

FIG. 3 is a side view of the connection mechanism of an apparatus tripod between its main body and its tubular legs according to the first embodiment.

FIG. 4 is a side view of an apparatus tripod in an operating (open) condition according to the first embodiment.

FIG. 5 is an exploded view of the connection mechanism of an apparatus tripod between its main body and its tubular legs according to the first embodiment

FIG. 6 is a cross-section view of the connection mechanism of an apparatus tripod between its main body and its tubular legs according to the first embodiment.

FIG. 7 is a cross-section view of the connection mechanism of an apparatus tripod between its main body and its tubular legs according to a second embodiment.

FIG. 8 is a cross-section view of the connection mechanism of an apparatus tripod between its main body and its tubular legs according to a third embodiment.

FIG. 9 is an exploded view of the connection mechanism of an apparatus tripod between its main body and its tubular legs according to the third embodiment.

### DETAILED DESCRIPTION OF THE PREFERRED EMBODIMENTS

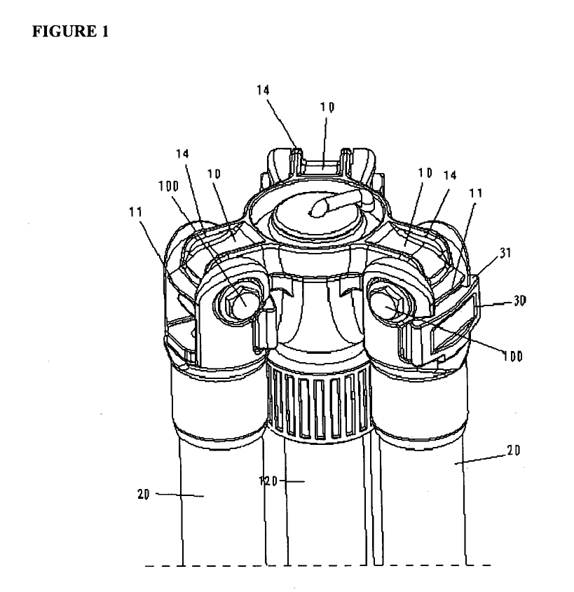

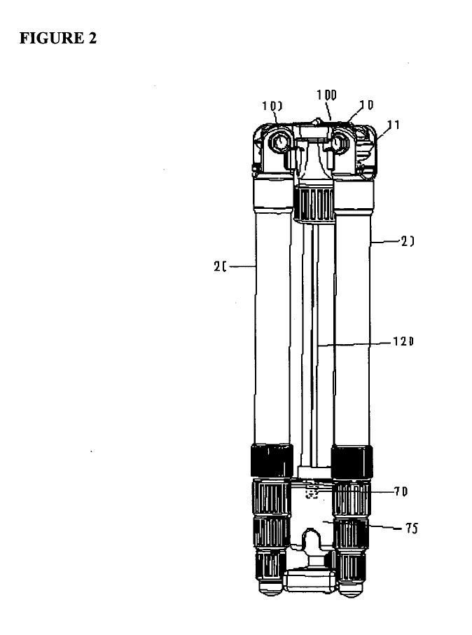

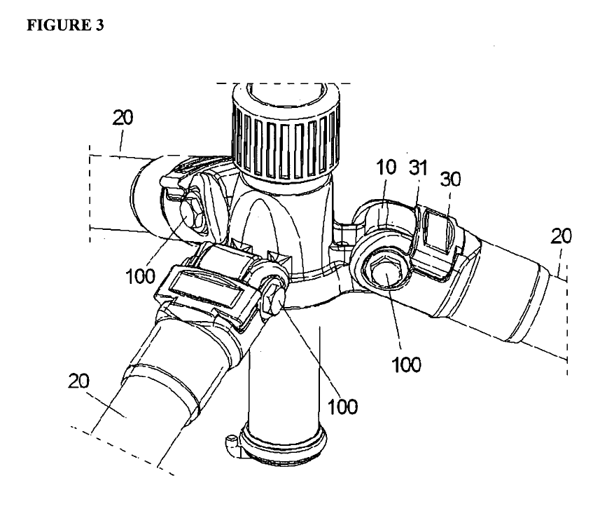

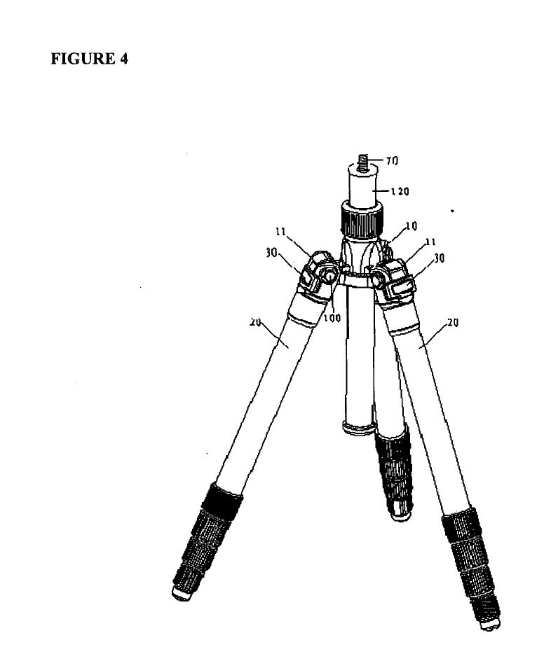

Referring to FIGS. 1-6, according to a first embodiment, a novel reverse foldable apparatus tripod comprises a main body 10 and three legs 20. The main body 10 comprises three radially extending arms 14. The main body 10 can assume a star shape, a spider shape, or an honeycomb shape. Preferably, the main body 10 has three evenly distributed arms. One or more projections 11 are disposed on the arms 14. The projections 11 can have various angles and various heights. Preferably, the projections 11 have a tooth shape. A bearing 90 is positioned in the middle of the arms 14. Each leg 20 has a top end 24 adjacent to the main body 10. The top end 24 of the legs 20 has a fork shape, with a flat surface 27 and two bifurcate plates 28 facing each other. The two bifurcate plates 28 each have a pivot opening 25 in the middle thereof. The legs 20 are pivotally connected to the arms 14 when the pivot openings 25 on the two bifurcate plates 28 are aligned with the bearing 90 on the arm 14. Any suitable connecting mechanism can be used, such as screws 100, a hinge, or a bolt and nuts. Preferably, the legs 20 are tubular. More preferably, the tubular legs have a plurality of tubular parts that are telescopically movable. Preferably, the reverse foldable apparatus tripod has three identical legs. Each leg 20 can pivot through about 180 degrees with respect to the main body 10, between a first position wherein the leg is generally parallel to and below the main body, and a second position wherein the leg is generally parallel to and above the main body. Each projection 11 releasably fixes the connected leg at a third position between the first and second positions. When the legs 20 are pivoted into the second position, the main body 10 does not extend substantially beyond the top end of the legs 20.

A circular opening 13 is positioned in the middle of the main body 10. A center column 120 is movably attached to the circular opening 13 of the main body 10. The center column 120 is secured to the main body 10 by tightening a clip 102. The clip 102 is supported by a sleeve member 101 disposed on the main body 10. A mounting screw 70 is secured to the top end of the center column 120. The mounting screw 70 supports any device, such as a ballhead, which is attached and then used as a means for mounting apparatus.

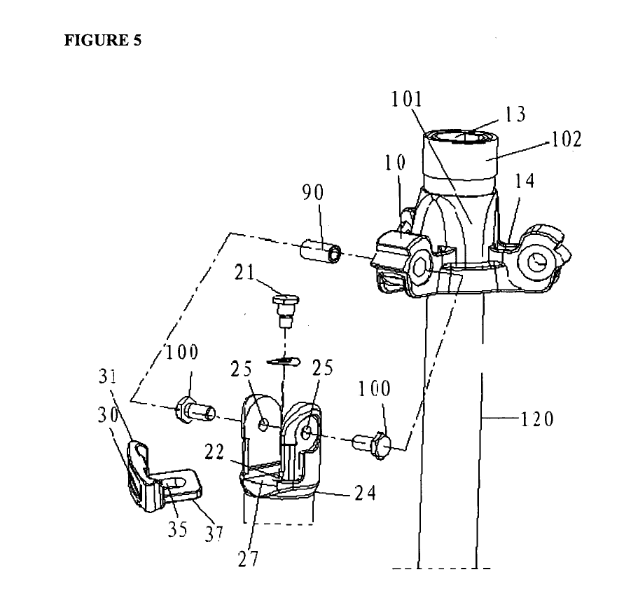

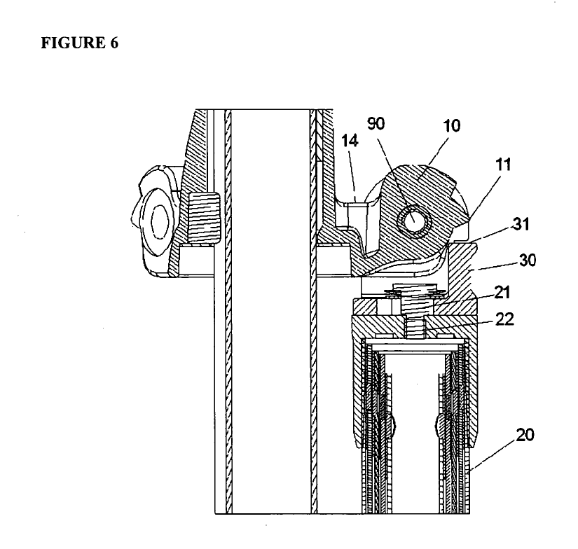

Referring to FIGS. 5 and 6, the flat surface 27 at the top end of the tubular legs 20 has an opening 22. A pin or a screw 21 is positioned in the opening 22. The pin 21 attaches the movable angle lock 30. A movable angle lock 30 is captured against the flat surface 27 by the bottom of the pin 21. The angle lock 30 has an L shape, with a first end 31 protruding towards the projections 11 on the main body 10, and a second end 37 rests on the top of the flat surface 27. A slot 35 is located in the middle of the second end 37. Preferably, the slot 35 is kidney shaped. The movable angle lock 30 can move radially relative to the axis of the center column 120 on the main body 10 along the slot 35. The angle lock 30 engages the projection 11 on the arm 14. The angle lock 30 is configured to move in a radial path, relative to the main body 10, into and out of engagement with the projection 11. As used herein, the term “radially” means diverging from a center at any angle. The angle lock 30 is configured to lock the leg 20 in the first position, in the second position, or in the third position.

Referring to FIG. 6, the first end 31 of the angle lock 30 is adapted to engage one of the projections 11 when the angle lock 30 is pushed inwardly. The angle lock 30 is biased toward engagement with the corresponding projection 11. When the angle lock 30 is pulled out, the first end 31 disengages from the projections 11. The tubular legs 20 can pivotally rotate along the bearing 90 on the main body 10. For example, when the angle lock 30 moves outwardly along the slot 35 by a distance equal to the arc length of the leg 20 moving toward the projection 11, the first end 31 of the angle lock 30 engages the projection 11. As a result, the legs 20 are opened and secured at a certain angle. When the angle lock 30 moves outwardly along the slot 35 by a distance, for example, more than the maximal arc length of the leg 20 moving toward the projections 11, the projections 11 do not engage the first end 31 of the angle lock 30. The legs 20 can be reversely folded by rotating the same upwardly, passing the projections 11. When the legs 20 are in the second position, the apparatus mount is surrounded by the legs 20. In other words, a unique element of this device is the way in which the tripod allows provision to contain a typical ballhead or other apparatus mount wholly within the confines of the compressed tripod legs 20. This unique element renders the tripods occupy a smaller space, are easier to move, and have a more elegant appearance. Also, the ballhead or other apparatus mount can be protected by the compressed tripod legs 20.

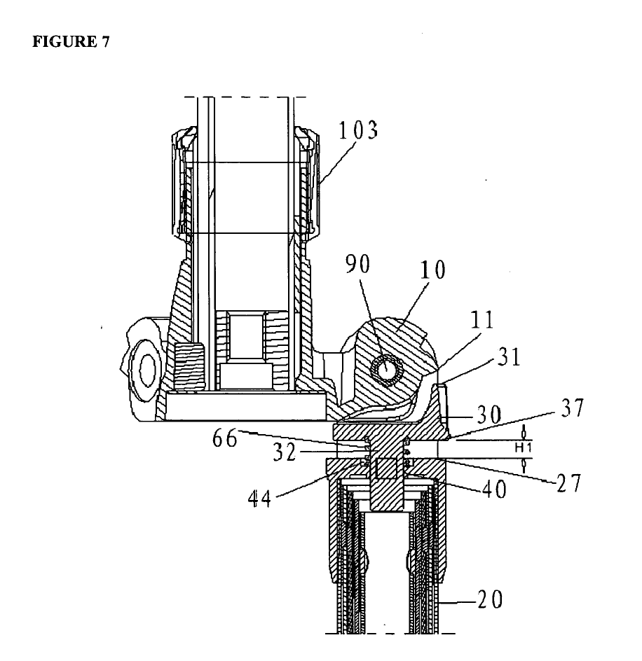

Referring to FIG. 7, according to a second embodiment, a reverse foldable apparatus tripod comprises a main body 10 and three legs 20. The legs 20 are pivotally connected to the main body 10 in a way similar to the first embodiment. The reverse foldable apparatus tripod according to the second embodiment uses a different mechanism to achieve the reverse folding of the same. Still referring to FIG. 7, the flat surface 27 of the legs 20 has a guiding opening 40 in the middle thereof. A recessed opening 44 is centered at the top of the guide opening 40. A movable angle lock 30 is centered on the top of the legs 20. The movable angle lock 30 has an L shape, with a first end 31 protruding towards the projections 11 on the main body 10, and a second end 37 horizontal with the top of the flat surface 27. A post 32 protrudes from the second end 37, projecting toward the legs 20.

Still referring to FIG. 7, a tensioning spring 66 is positioned surrounding the post 32. The post 32 movably engages the guiding opening 40. The tensioning spring 66 sits on the recessed opening 44 and supports the movable angle lock 30. The tensioning spring 66 biases the movable angle lock 30 toward the main body 10 such that a height H1 exists between the lower surface of the second end 37 of the movable angle lock 30 and the flat surface 27 on the top of the leg 20 when the movable angle lock 30 is not pressed down. When the movable angle lock 30 is pressed down and, for example, the distance traveled by the post 32 is equal to the arc length of the leg 20 moving toward the projection 11, the first end 31 of the angle lock 30 engages the projection 11. As a result, the legs 20 are opened and secured at a certain angle. When the post 32 of the angle lock 30 moves along the guiding opening 40 by a distance, for example, more than the maximal arc length of the leg 20 moving toward the projections 11, the projections 11 do not engage the first end 31 of the angle lock 30. The legs 20 can be reversely folded by rotating the same upwardly, passing the projections 11.

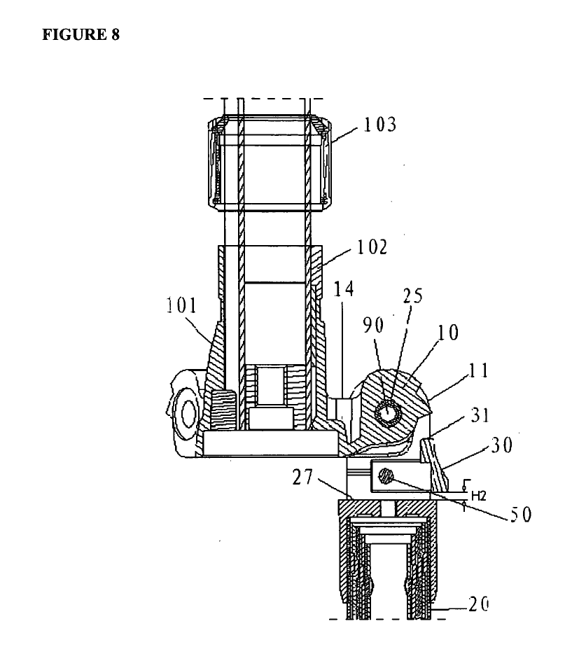

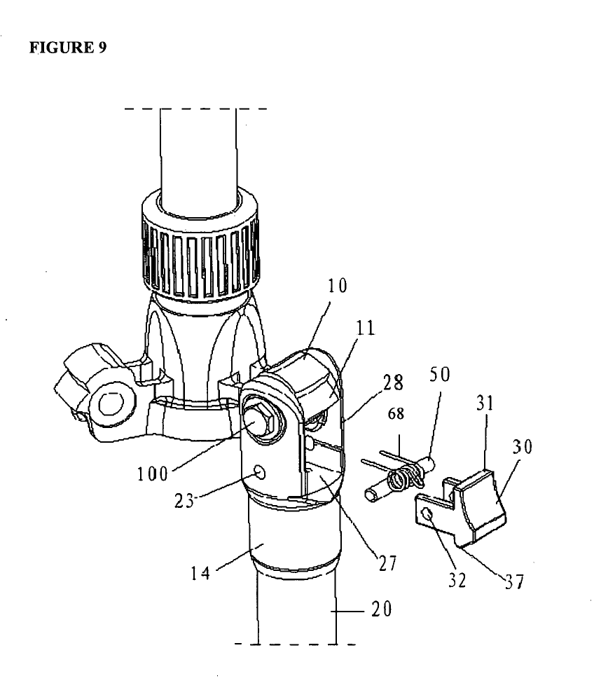

Referring to FIGS. 8 and 9, according to a third embodiment, a reverse foldable apparatus tripod comprises a main body 10 and three of legs 20. The legs 20 are pivotally connected to the main body 10 in a way similar to the first embodiment. The reverse foldable apparatus tripod according to the third embodiment another novel mechanism to achieve the reverse folding of the same. Still referring to FIGS. 8 and 9, one guiding pivot opening 23 is disposed on each of the two bifurcate plates 28. The guiding pivot openings 23 are disposed between the flat surface 27 of the top end 14 of the leg 20 and the pivot openings 25 on the two bifurcate plates 28. The pivot openings 25 correspond to the bearing 90 axis on the arm 14. A movable angle lock 30 is positioned between the arm 14 and the flat surface 27. The movable angle lock 30 has an L shape, with a first end 31 protruding towards the projections 11 on the main body 10, and a second end 37 on the top of the flat surface 27. The movable angle lock 30 has an opening 32 located at the inside end of the movable angle lock 30. The movable angle lock 30 is pivotally connected to the leg 20 at the opening 32 and the guiding pivot openings 23 by a screw, a pin, or any other suitable means.

Preferably, the movable angle lock 30 is pivotally connected to the leg 20 by a guiding pin 50. A positioning spring 68 surrounds the guiding pin 50. The positioning spring 68 biases the movable angle lock 30 toward the main body 10 such that a height H2 exists between the lower surface of the second end 37 of the movable angle lock 30 and the flat surface 27 on the top end 14 of the leg 20 when the movable angle lock 30 is not pressed down. When the movable angle lock 30 is pressed down, it rotates along the axis of the guiding pin 50. When the arc length traveled by the rotating angle lock 30 is, for example, equal to the arc length of the leg 20 moving toward the projection 11, the first end 31 of the angle lock 30 engages the projection 11. As a result, the legs 20 are opened and secured at a certain angle. When the angle lock 30 rotates along the guiding pin 50 by an arc length, for example, more than the maximal arc length of the leg 20 moving toward the projections 11, the projections 11 do not engage the first end 31 of the angle lock 30. The legs 20 can be folded in reverse by rotating the same upwardly, passing the projections 11.

Many modifications and other embodiments of the present disclosure will come to mind to one skilled in the art to which the present disclosure pertains having the benefit of the teachings presented in the foregoing description; and it will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A tripod comprising:
a main body with three radially extending arms,
a leg connected to each arm so as to pivot through about 180 degrees with respect to the main body, so as to pivot between a first position wherein the leg is generally parallel to and below the main body, and a second position wherein the leg is generally parallel to and above the main body,
each arm including at least one projection for releasably fixing the connected leg at a third position between the first and second positions, and
each leg including an angle lock for engaging the projection on the arm, the angle lock mounted to a top end of the leg and configured to move in a radial path, relative to the main body, into and out of engagement with the projection.

2. The tripod of claim 1 wherein each angle lock is biased toward engagement with the corresponding projection.

3. The tripod of claim 1 wherein each arm includes two projections and wherein each angle lock engages both projections, to thereby allow fixing each leg at first and second desired angles.

4. The tripod of claim 3 wherein each angle lock is biased toward engagement with the corresponding projections.

5. The tripod of claim 1 wherein each angle lock comprises a slot which is captured by a pin attached to the top end of the corresponding leg.

6. The tripod of claim 1 wherein each angle lock has a generally L-shaped cross-section with a first portion oriented generally parallel to the leg and a second portion oriented generally perpendicular to the leg, and wherein the first portion is adapted to engage the projection.

7. The tripod of claim 6 wherein the angle lock is connected to the top end of the leg by a pin captured by a slot in the second portion.

8. The tripod of claim 1, further comprising a center column movably attached to the main body in a center opening disposed in the middle of the main body.

9. The tripod of claim 8, further comprising an apparatus mount disposed at one end of the center column, wherein when the legs are in the second position, the apparatus mount is surrounded by the legs.

10. The tripod of claim 1 wherein when the legs are pivoted into the second position, the main body does not extend substantially beyond the top end of the legs.

11. The tripod of claim 1 wherein the angle lock is configured to lock the leg in the first position.

12. The tripod of claim 1 wherein the angle lock is configured to lock the leg in the second position.

13. A tripod comprising:
a main body with three radially extending arms,
a leg connected to each arm so as to pivot through about 180 degrees with respect to the main body, so as to pivot between a first position wherein the leg is generally parallel to and below the main body, and a second position wherein the leg is generally parallel to and above the main body,
each arm including at least one projection for releasably fixing the connected leg at a third position between the first and second positions, and
each leg including an angle lock for engaging the projection on the arm, the angle lock mounted to a top end of the leg and configured to move in an axial path, relative to the leg, into and out of engagement with the projection.

14. The tripod of claim 13 wherein each angle lock is biased toward engagement with the corresponding projection.

15. The tripod of claim 13 wherein each arm includes two projections and wherein each angle lock engages both projections, to thereby allow fixing each leg at first and second desired angles.

16. The tripod of claim 13 wherein the angle lock includes a post received within a hole in the top end of the leg.

17. The tripod of claim 16 wherein each angle lock is biased toward engagement with the corresponding projection, the biasing means comprising a spring surrounding the post.

18. The tripod of claim 13, further comprising a center column movably attached to the main body in a center opening disposed in the middle of the main body.

19. The tripod of claim 18, further comprising an apparatus mount disposed at one end of the center column, wherein when the legs are in the second position, the apparatus mount is surrounded by the legs.

20. The tripod of claim 13 wherein when the legs are pivoted into the second position, the main body does not extend substantially beyond the top end of the legs.

21. The tripod of claim 13 wherein the angle lock is configured to lock the leg in the first position.

22. The tripod of claim 13 wherein the angle lock is configured to lock the leg in the second position.

23. A tripod comprising:
a main body with three radially extending arms,
a leg connected to each arm so as to pivot through about 180 degrees with respect to the main body, so as to pivot between a first position wherein the leg is generally parallel to and below the main body, and a second position wherein the leg is generally parallel to and above the main body,
each arm including at least one projection for releasably fixing the connected leg at a third position between the first and second positions, and
each leg including an angle lock for engaging the projection on the arm, the angle lock pivotally mounted to a top end of the leg and configured to pivot into and out of engagement with the projection.

24. The tripod of claim 23 wherein each angle lock is biased toward engagement with the corresponding projection.

25. The tripod of claim 23 wherein each arm includes two projections and wherein each angle lock engages both projections, to thereby allow fixing each leg at first and second desired angles.

26. The tripod of claim 23 wherein the angle lock includes a pin, wherein the angle lock pivots about the pin.

27. The tripod of claim 26 wherein each angle lock is biased toward engagement with the corresponding projection, the biasing means being a spring surrounding the pin.

28. The tripod of claim 23, further comprising a center column movably attached to the main body in a center opening disposed in the middle of the main body.

29. The tripod of claim 28, further comprising an apparatus mount disposed at one end of the center column, wherein when the legs are in the second position, the apparatus mount is surrounded by the legs.

30. The tripod of claim 23 wherein when the legs are pivoted into the second position, the main body does not extend substantially beyond the top end of the legs.

31. The tripod of claim 23 wherein the angle lock is configured to lock the leg in the first position.

32. The tripod of claim 23 wherein the angle lock is configured to lock the leg in the second position.
